(19) United States
(12) Patent Application Publication
(10) Pub. No.: US 2005/0034742 A1
(43) Pub. Date: Feb. 17, 2005

(54) Cleaning method and cleaning apparatus

(75) Inventors: Shunsuke Saito, Suzuka-shi (JP); Shoichi Okano, Akiruno-shi (JP); Kaoru Kanezuka, Iruma-shi (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: KAIJO Corporation, Hamura-city (JP)

(21) Appl. No.: 10/639,171

(22) Filed: Aug. 11, 2003

(51) Int. Cl. B08B 3/12

(52) U.S. Cl. 134/1; 134/2; 134/15; 134/26; 134/32; 134/34; 134/37; 134/40

(57) ABSTRACT

The invention provides a cleaning method and a cleaning apparatus in which the quantity of cleaning solvent used may be reduced, and high cleaning property is achieved. The cleaning method of the invention includes a first step of transporting a plate-shaped object to be processed on a support stand by a transporting unit and making hydrophiling preparation on at least one surface thereof, a second step of forming a liquid film on a surface of the object to be processed, on which hydrophiling preparation has made, and a third step of irradiating ultrasonic energy from an ultrasonically oscillating surface provided in the vicinity of the liquid film formed on the surface of the object to be processed so as to be capable of coming into contact therewith onto the object to be processed for cleaning.

### BACKGROUND OF THE INVENTION

1. Field of the Invention

The present invention relates to a cleaning method and a cleaning apparatus and, more specifically, to a water-saving cleaning method and a cleaning apparatus used for wet processes such as cleaning, etching, development, and peeling.

2. Description of the Related Art

Technologies and problems in the related art will be described from the viewpoint of “cleaning” of various fluid treatments for the surfaces of silicon substrates, liquid-crystal display substrates, solar panels, magnetic substrates, substrates for plastic packages, and other large-size substrates (hereinafter, referred also as a “substrate”).

One cleaning apparatus in the relate art is disclosed, for example, in Japanese Laid-Open Application No.H6-461. Referring now to FIG. 1 and FIG. 2, this cleaning apparatus in the related art will be described below. FIG. 1 is a front cross-sectional view of the cleaning apparatus in the related art. FIG. 2 is a bottom view of the cleaning apparatus in the related art shown in FIG. 1.

As shown in FIG. 1, a cleaning apparatus 30 includes a case 11 formed into a longitudinal box shape, being concaved in cross section, an ultrasonic transducer 15 disposed in a recess of the case 11, and an ultrasonic oscillator 16 for driving the ultrasonic transducer 15 with ultrasonic signals at, for example, 950 kHz. The case 11 comprises an upper case including a diaphragm 11a of the ultrasonic transducer 15 disposed in the recess, and a lower case including a reflecting plate 11b disposed so as to face the diaphragm 11a and form an angle of θ (0<θ<10°) with respect to a surface of the ultrasonic transducer 15.

The upper case and the lower case are fixedly secured to each other with a bolt 21 and a nut 22 with a packing 19 being interposed therebetween. As shown in FIG. 2, the lower case includes three cleaning solvent inlets 12 on one side thereof, two overflow outlets 14 on the side opposite from the cleaning solvent inlets 12, an elongated cleaning solvent discharging portion 26 formed at the center of the reflecting plate 11b, and a slit 25 formed at the center of the cleaning solvent discharging portion 26.

A current plate 18, being substantially L-shape in cross section, is attached on one side of the packing 19. The current plate 18 is formed with a plurality of slits 20 on the lower portion thereof so as to serve as a member for performing rectification.

The operation of the cleaning apparatus 30 will be described below.

As shown in FIG. 1, when cleaning solvent 24, such as extra pure water, hydrogen water, and so on, is supplied through the cleaning solvent inlets 12 into the case 11 in the direction indicated by an arrow X, the cleaning solvent 24 is rectified by the slits 20 on the current plate 18. Then the cleaning solvent 24 is flown in the case 11 as a laminar flow, and is spouted out from the cleaning solvent spout 13 onto an object to be processed 17 in a uniform shape. At this moment, the ultrasonic transducer 15 is driven by a voltage of a predetermined frequency, and emits ultrasonic waves via the diaphragm 11a toward the reflecting plate 11b, which corresponds to the bottom of the case 11. Since the reflecting plate 11b is inclined by a predetermined angle θ, ultrasonic waves 23a and 23b reflected from the reflecting plate 11b finally reach the cleaning solvent spout 13 in an alternate succession of reflections, and are guided through the cleaning solvent discharging portion 26, so that powerful ultrasonic cleaning solvent is injected from the slit 25 onto the object to be processed 17.

Therefore, the ultrasonic cleaning apparatus 30 in the related art cleans the object to be processed 17, such as a semiconductor wafer or a glass plate, while transporting the same along a route passing under the cleaning solvent spout 13 by a transporting device (not shown), such as rollers, at a regular speed, for example, in the direction indicated by an arrow Y.

However, since the cleaning apparatus 30 is adapted to spout the cleaning solvent 24 through the slit 25, the area on the object to be processed 17 on which the cleaning solvent 24 excited by ultrasonic waves is applied is extremely narrow, and hence it is necessary to provide a plurality of pieces of ultrasonic cleaning apparatus 30 simultaneously for achieving satisfactory cleaning effect. As a consequence, the cost may increase as well as the quantity of cleaning solvent 24 to be used. For example, in order to perform cleaning of an object to be processed having dimensions of 550 mm×650 mm×t0.7 mm by using cleaning solvent such as hydrogen gas saturated extra pure water, at least 25-30 L/min of solvent for cleaning and rinsing is required for ensuring stable application of ultrasonic waves. The reason why as much as 25-30 L/min of cleaning and rinsing solvent is required is that the frequency of ultrasonic waves is set to a high value, and the slit of the ultrasonic cleaning nozzle is set to a small width. If the substrate to be processed is increased in size, larger amount of solvent is required for cleaning and rinsing.

When hydrogen gas saturated extra pure water is employed as cleaning solvent for performing the cleaning process by the cleaning apparatus 30, a hydrogen gas saturated extra pure water manufacturing device is required to be capable of supplying a large amount of hydrogen gas saturated extra pure water in a stable manner. Consequently, the size of electrodes required for electrolysis of water increases, and hence a module (permeable membrane) for resolving gas (ozone, hydrogen) generated by electrolysis effectively in the cleaning solvent is also increased in size. Accordingly, equipment as a whole is also increased in size, thereby resulting in high costs.

In addition, in the cleaning apparatus 30, since the distance between the ultrasonic element (ultrasonic transducer 15) and the object to be processed 17 is long, significant attenuation of ultrasonic power is observed. In the case of cleaning using ultrasonic waves in the range of MHz band, ultrasonic waves from 0.7 to 1.5 MHz are used. When considering effects on the object to be processed 17 such as cavitations, ultrasonic waves of 0.7 MHz, which is the lower limit, are used. In contrast, when effective cleaning power cannot be achieved, ultrasonic waves of 1.5 MHz, which is the higher limit, are used. Ultrasound waves in the range higher than 1.5 MHz are used when a problem of geometrical arrangement of the ultrasonic element is present, that is, when the distance between the ultrasonic element (ultrasonic transducer 15) and the object to be processed 17 is long and thus a large attenuation of ultrasonic power is resulted, as shown in FIG. 1.

### SUMMARY OF THE INVENTION

Accordingly, it is an object of the invention to provide a cleaning method and a cleaning apparatus in which the quantity of cleaning solvent to be used may be reduced, and high quality of cleaning results may be achieved.

A cleaning method according to the invention includes a first step of transporting a plate-shaped object to be processed by a transporting device on a support stand and making hydrophiling preparation on at least one of the surfaces of the object to be processed, a second step of forming a liquid film on the surface of the object to be processed, on which hydrophiling preparation has made, and a third step of irradiating ultrasonic energy from an ultrasonically oscillating surface provided in the proximity of the liquid film formed on the surface of the object to be processed so as to be capable of coming into contact therewith onto the object to be processed for cleaning.

According to the cleaning method of the invention, hydrophiling preparation is made by optical cleaning or ozone cleaning.

According to the cleaning method of the invention, the optical cleaning is performed by irradiating ultraviolet light onto the object to be processed by an excimer lamp or a low-pressure mercury lamp.

According to the cleaning method of the invention, the liquid film is formed by hydrogen gas saturated extra pure water.

According to the cleaning method of the invention, the saturated concentration of the hydrogen gas saturated extra pure water is 0.8 ppm or higher.

According to the cleaning method of the invention, the liquid film is formed by being mixed with air and applied on the hydrophilic surface of the object to be processed from a two-fluid nozzle.

According to the cleaning method of the invention, the object to be processed is cleaned by being transported horizontally or vertically by the transporting device.

According to the cleaning method of the invention, the cleaning method further includes a fourth step of drying the object to be processed by one or combination of IPA steam drying, spin drying, Marangoni drying, and air knife drying.

The cleaning apparatus of the invention irradiates ultrasonic energy onto the object to be processed and cleaning the same by a transporting unit for transporting the plate-shaped object to be processed on a support stand by transporting means, a hydrophiling unit for making hydrophiling preparation on at least one of the surfaces of the object to be processed, and an ultrasonic cleaning unit including a cleaning solvent supplying device for forming a liquid film on the surface of the object to be processed, on which hydrophiling preparation has made, and an ultrasonic exciting device provided in the vicinity of the liquid film formed on the object to be processed so as to be capable of coming into contact therewith.

According to the cleaning apparatus of the invention, the hydrophiling unit includes au ultraviolet light irradiating device or an ozone water cleaning unit.

According to the cleaning apparatus of the invention, the ultraviolet light irradiating device irradiates ultraviolet light onto the object to be processed by an excimer lamp or a low pressure mercury lamp.

According to the cleaning apparatus of the invention, the liquid film is formed by a hydrogen gas saturated extra pure water supplying device.

### BRIEF DESCRIPTION OF THE DRAWINGS

FIG. 1 is a front cross-sectional view of a cleaning apparatus in the related art;

FIG. 2 is a front bottom view of the cleaning apparatus in the related art;

FIG. 3 is a schematically drawing of a cleaning apparatus according to the invention, in which FIG. 3A shows a state in which a dryer unit used in the fourth step is constructed of a spin dryer, and FIG. 3B shows a state in which the dryer unit used in the fourth step is constructed of an air knife;

FIG. 4 is a process drawing of horizontal transportation according to the cleaning method of the invention;

FIG. 5 is a drawing showing a principle of generation of ultraviolet light by an excimer lamp;

FIG. 6 is a drawing showing a principle of optical cleaning using an ultraviolet treatment apparatus;

FIG. 7 is a perspective view showing a state in which hydrogen gas saturated extra pure water is supplied to the object to be processed through apertures formed on a nozzle pipe of the hydrogen gas saturated extra pure water supplying device, and an ultrasonic exciting device;

FIG. 8 is a side view showing a method of supplying hydrogen gas saturated extra pure water in the hydrogen gas saturated extra pure water supplying device, in which FIG. 8A is a side view showing a state in which hydrogen gas saturated extra pure water is supplied to the object to be processed from a plurality of apertures formed on the nozzle pipe, and FIG. 8B is a side view showing a state in which hydrogen gas saturated extra pure water is supplied to the object to be processed from a plurality of dual-fluid nozzles;

FIG. 9is a drawing showing a state in which three ultrasonic exciting devices 66 are provided and the hydrogen gas saturated extra pure water supplying devices 61 are added to all these three ultrasonic exciting devices, respectively;

FIG. 10 is a drawing showing a state in which three ultrasonic exciting devices 66 are provided and the hydrogen gas saturate extra pure water supplying device 61 for the second ultrasonic exciting device 66 is omitted from the state shown in FIG. 9;

FIG. 11 is a table showing the cleaning result in the case shown in FIG. 9;

FIG. 12 is a table showing the cleaning result in the case shown in FIG. 10;

FIG. 13 is a graph showing comparison between the cleaning results shown in FIG. 11 and FIG. 12;

FIG. 14 is a drawing showing comparison of cleaning effect among hydrogen gas saturated extra pure water, pure water, and degassed film water;

FIG. 15 shows a result of cleaning of particle on the pure and natural glass substrate with and without ultraviolet treatment;

FIG. 16 shows a result of cleaning of particles on the substrate having a Cr film formed thereon with and without ultraviolet treatment;

FIG. 17 is a drawing showing an evaluation of the contact angle of the pure and natural glass substrate with and without ultraviolet treatment; and

FIG. 18 is a front view showing a structure of a spin dryer.

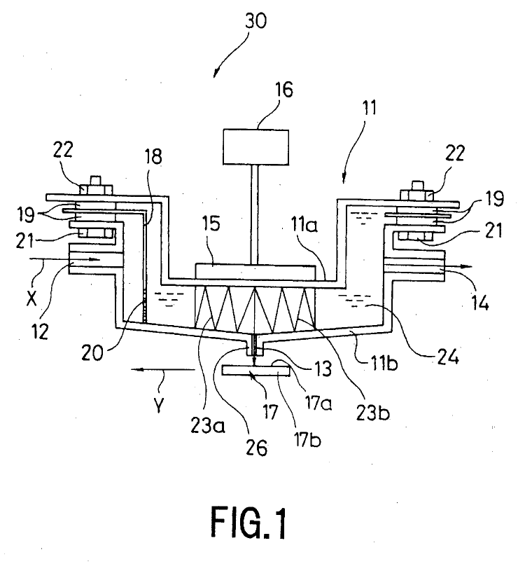

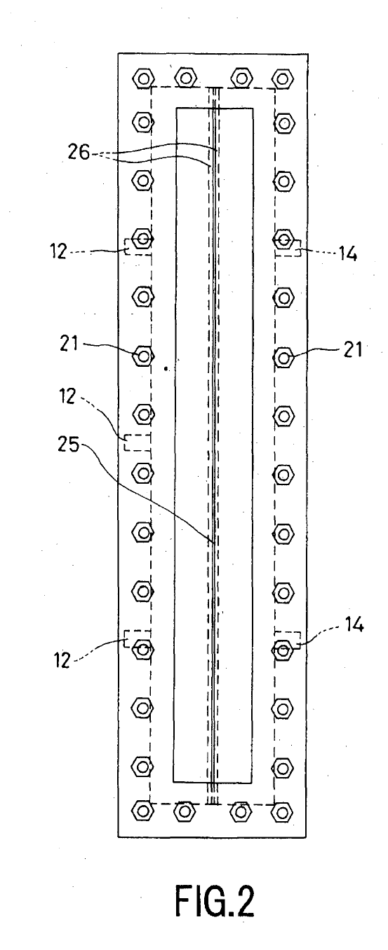

### DESCRIPTION OF THE PREFERRED EMBODIMENTS

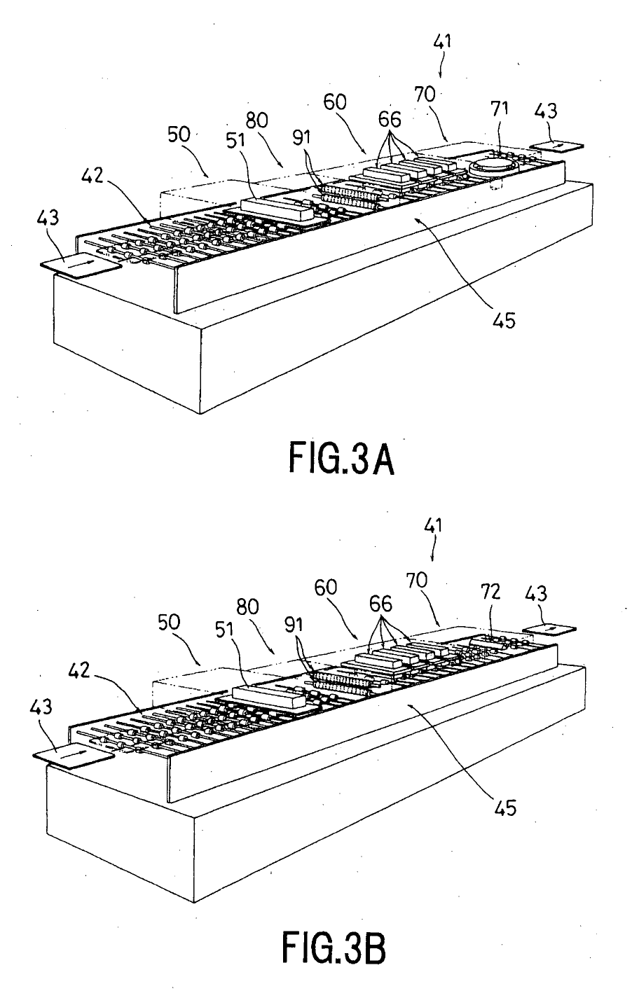

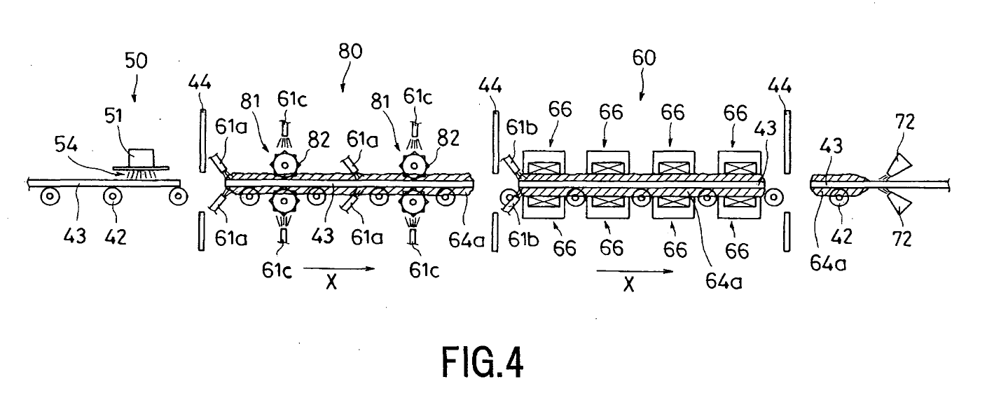

Referring now to the drawings, embodiments of a cleaning method and a cleaning apparatus according to the invention will be described. FIG. 3 generally shows the cleaning apparatus of the invention. FIG. 3A shows a state in which a dryer unit used in the fourth step is constructed of a spin dryer, and FIG. 3B shows a state in which the dryer unit used in the fourth step is constructed of an air knife. FIG. 4 is a general explanatory drawing showing a step of transporting according to the cleaning apparatus of the invention.

As shown in FIG. 3 and FIG. 4, the cleaning apparatus 40 includes a hydrophiling unit 50 provided on an elongated support stand 45, an ultrasonic cleaning unit 60, a dryer unit 70, and a brush unit 80 when needed.

According to the invention, organic substances attached on a substrate 43 are removed by ultraviolet light 54 for enhancing wettability, and particles are removed by ultrasonic waves. In other words, in the first step, organic substances are decomposed and peeled from the surface of the substrate 43 by irradiating ultraviolet light 54 on the substrate 43 or by cleaning with ozone water. This process corresponds to hydrophiling preparations because of such property that reduction of organic substances attached on the surface of the substrate 43 promotes hydrophilic nature (becomes wettable). In the second step, when supplying hydrogen gas saturated extra pure water to the substrate 43, a liquid film 64a of the hydrogen gas saturated extra pure water 64 can easily be formed on the substrate 43 only with a small quantity of water since the substrate 43 is already hydrophiled (wettable) in the first step. In the third step, since an ultrasonically oscillating surface 68c is provided in the vicinity of the liquid film of the hydrogen gas saturated extra pure water 64 formed on the substrate 43 so as to be capable of coming into contact therewith, attenuation of ultrasonic power is reduced. Therefore, in cooperation with an effect of using the hydrogen gas saturated extra pure water used as cleaning solvent, a high cleaning effect is achieved, while enabling propagation of ultrasonic power to the substrate 43 with a small quantity of cleaning solvent.

As shown in FIG. 3 and FIG. 4, drive rollers 42 are disposed at regular intervals longitudinally of the support stand 45 as a transporting device (transporting unit) for supporting the thin plate-shaped rectangular substrate 43, which corresponds to the object to be processed and transporting the same in the horizontal direction on the back side of the substrate 43. According to the invention, the surface of the substrate 43 is wetted and formed with the liquid film prior to irradiating ultrasonic waves thereon. Therefore, optical cleaning is performed as the first step of the cleaning method for promoting hydrophilic nature in order to enable formation of the liquid film to be achieved only with a small quantity of cleaning solvent 64, such as hydrogen gas saturated extra pure water or extra pure water. Making hydrophiling preparation in the first step means to provide hydrophilic nature (wettability) to the surface of the substrate by decomposing and peeling organic contaminants attached on the surface of the substrate 43 by irradiating ultraviolet light 54 on the substrate 43 or by cleaning with ozone water in the first step as a preliminary step toward the second step of supplying the hydrogen gas saturated ultra pure water 64 to the substrate 43 for forming the liquid film 64a.

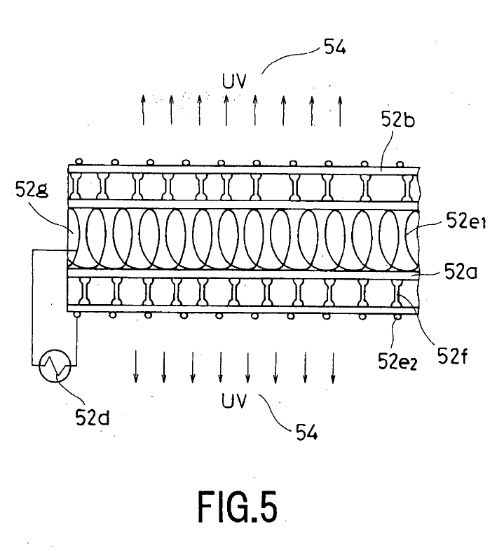

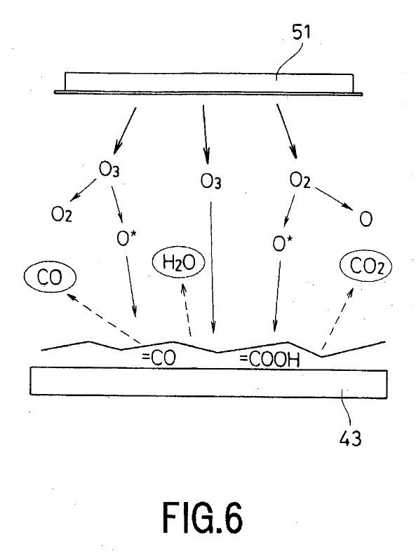

As shown in FIG. 3 and FIG. 4, an ultraviolet light irradiating device 51 irradiates ultraviolet light 54 on the front and back surfaces of the substrate 43 being transported by rotation of the drive rollers 42. This optical cleaning by irradiation of ultraviolet light is capable of removing the organic contaminants by activities of light and active oxygen. Generally, ultraviolet light is irradiated on the substrate using a low pressure mercury lamp (not shown) or an excimer lamp 52 (shown in FIG. 5). In the invention as well, both of the excimer lamp and the low pressure mercury lamp may be used. Ultraviolet light is irradiated on air containing oxygen or oxygen gas to generate ozone. Then, active oxygen, which is a decomposed gas of ozone, is generated from the ozone. When the active oxygen is brought into contact with the substrate, the organic substances on the substrate are decomposed into an atomic element, such as carbon. The resultant atomic element is then bound with oxygen particles existing around the substrate and, consequently, is decomposed and peeled from the substrate in a form of CO₂.

A pair of ultraviolet light irradiating devices 51 is disposed above and below the substrates 43 corresponding to both surfaces of the substrate 43. When only one side is to be cleaned, the process described above must simply be performed only on one side. When the both sides of the substrate 43 are to be cleaned, however, it is preferable to irradiate ultraviolet light on both of the front and back sides. It is also possible to provide the ultraviolet light irradiating device 51 only on one side. While the quantity of ultraviolet light 54 to be irradiated may be set as appropriate depending on the transporting speed or the type of the substrate, values in the range of 10 to 200 mJ/cm² are preferable.

FIG. 5 is a drawing showing an example of the excimer lamp 52. As shown in FIG. 5, the excimer lamp 52 includes an inner tube 52a and an outer tube 52b formed of quartz glass, and discharge gas 52c, such as xenon, is encapsulated in a space formed therebetween. Electrodes 52e1 and 52e2 are provided on the inside and outside thereof, and a high voltage is applied thereto by a AC power supply 52d. Accordingly the excimer lamp 52 emits ultraviolet light 54. In other words, the quartz glass, which is a dielectric material, applied with a high voltage causes microdischarge 52f by the action of dielectric barrier discharge (silent discharge), and a discharge gas 103 encapsulated therein is excited and bound by energy generated therefrom, so that light with gas-specific wavelengths is emitted in the process of restoration of the excited gas molecules to its basic state.

Ultraviolet light 54 emitted from the excimer lamp 52 generates ozone and active oxygen by a photochemical reaction in an atmosphere containing oxygen in which the substrate 43 is placed and allows the surface of the substrate 43 to be exposed thereto, or is even irradiated directly to the substrate 43. Such cooperative activity achieves cleaning or improvement of the surface of the object to be processed.

A principle of optical cleaning is as follows. Oxygen O₂ absorbs ultraviolet light and generates ozone O₃. The generated ozone is decomposed and generates active Oxygen O(¹D). The ozone and active oxygen generated in this process has capability to oxidize contaminants attached on the surface of the substrate.
O₂hv→O(³P)+O(³p)
O₂+O(³P)→O₃→O₂+O(²D)
Since energy of ultraviolet light is very high and is higher than binding energy of many organic compounds, the bound state of such organic compounds is broken. These composite activities causes the organic substances to be decomposed and oxidized and, consequently splashed and removed from the surface of the substrate as water (H₂O) or carbon dioxide (CO₂).

Light with a wavelength of 172 nm emitted from the excimer lamp 52 are absorbed by oxygen molecules. The oxygen molecules generate excited active oxygen O (¹D) upon absorption of light of wavelengths with 175 nm or below.
O₂+hv (172 nm)→O(¹D)+O(³D)
Therefore, since active oxygen is effectively generated, and short-wavelength ultraviolet light of 172 nm is superior in decomposition of chemical bonding of contaminants, optical cleaning can be effectively performed.

By ultraviolet light 54 being irradiated on the substrate 43, organic substances attached on the substrate 43 are decomposed, peeled, and thus reduced. In association with reduction of organic substances, (wettability is increased), the angle of contact is reduced, and hydrophiling nature is improved (hydrophiled). Therefore, according to the invention, the organic substances are removed by ultraviolet light 54 so that wettability is improved, and then particles are removed by ultrasonic waves.

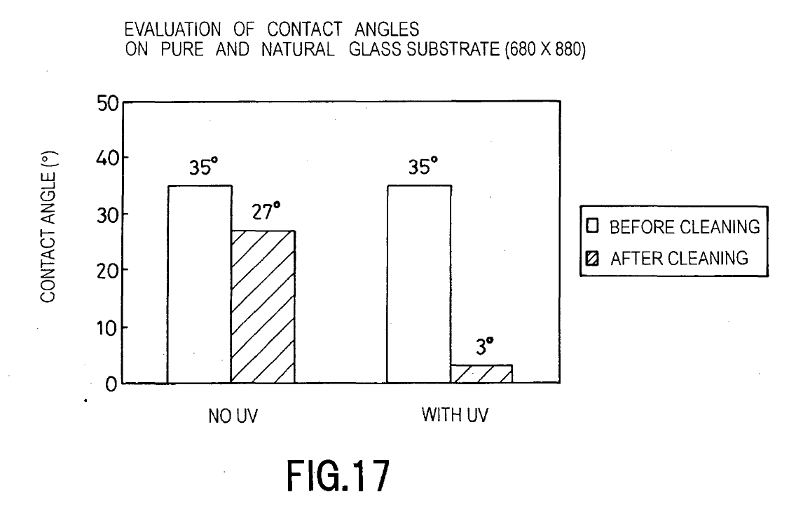

Variations in the surface condition of the substrate depending on the presence or absence of ultraviolet treatment will be shown in FIG. 17. FIG. 17 shows an evaluation of the angles of contact performed on a pure and natural glass substrate with and without ultraviolet treatment. When ultraviolet treatment is conducted, the organic substances attached on the substrate 43 is decomposed, and thus hydrophilic nature is generally provided. Since the hydrophilic surface is highly wettable, the angle of contact is decreased (less than 5°). Therefore, in order to verify the effect of ultraviolet treatment, the angle of contact on the surface of the substrate was measured and examined how wettability on the surface of the substrate had changed. As shown in FIG. 17, it was proved that the angle of contact is smaller on the substrate 43 which was subjected to ultraviolet treatment.

The hydrophiling preparation in the first step may be made by ozone water cleaning in which organic substance or metal is removed by sodium chlorite ozone water instead of optical cleaning performed by irradiation of ultraviolet light 54. There is a correlation between reduction of organic contaminants on the substrate and hydrophilic nature, an thus reduction of organic substance on the surface of the substrate by with ozone water cleaning contributes to reduce the angle of contact (increase wettability), so that hydrophiling preparation is completed. When performing ozone water cleaning in the first step, since it is intended to reduce the organic substances on the surface of the substrate and increase its hydrophilic nature, a large quantity of liquid as in the case of performing ozone water cleaning for the sole purpose of cleaning is not required, and only a small quantity of liquid sufficient for hydrophilic preparation will be enough.

When making hydrophilic preparation by ozone cleaning in the first step, since ozone gas and hydrogen gas can be generated simultaneously by water electrolyzation, ozone water for hydrophilic preparation and hydrogen gas saturated extra pure water for being supplied to and forming a liquid film on the substrate 43 in the second step can be generated with a single equipment by dissolving ozone gas and hydrogen gas into extra pure water via gas soluble modules, respectively.

After hydrophilic preparation in the first step has made, the substrate 43 is transferred by the drive rotor 42 and proceeds to the second step, that is, the step of supplying hydrogen gas saturated extra pure water. As shown in FIG. 3, after the substrate 43 has passed through the hydrophiling unit 50 in the first step, the substrate 43 is transferred to the ultrasonic cleaning unit 60 for the second and third steps.

It is also possible to provide the brush unit 80 for removing particles, which cannot be removed by ultrasonic cleaning in the third step, by a projection 82 provided on a rotary brush 81 before proceeding to the third step. As shown in FIG. 4, in the embodiment of the invention, cleaning effect is improved by performing the step of supplying hydrogen gas saturated extra pure water 64 to the substrate 43 to form the liquid film 64a and the step of removing particles, which cannot be removed by ultrasonic cleaning, by the rotary brush 81 as the second step. In this embodiment, in order to form the liquid film 64a on the substrate 43 before ultrasonic cleaning in the third step, a hydrogen gas saturated extra pure water supplying device 61 is provided. The brush unit 80 is provided in the step of supplying hydrogen gas saturated extra pure water 64 from the hydrogen gas saturated extra pure water supplying device 61 to the substrate 43, and the hydrogen gas saturated extra pure water supplying device includes a hydrogen gas saturated extra pure water supplying device 61a for forming the liquid film 64a by supplying the hydrogen gas saturated extra pure water 64 on the substrate 43, a hydrogen gas saturated extra pure water supplying device 61b for replenishing hydrogen gas saturated extra pure water 64 on the liquid film 64a before performing ultrasonic cleaning by an ultrasonic exciting device 66, and a hydrogen gas saturated extra pure water supplying device 61c for supplying hydrogen gas saturated extra pure water 64 on the rotary brush 81 of the brush unit 80 for wetting the rotary brush 80. The liquid film 64a is formed on the substrate 43 by the hydrogen gas saturated extra pure water supplying device 61a, and then before removing the particles formed on the substrate 43 by the rotary brush 81, the rotary brush 81 is wetted with hydrogen gas saturated extra pure water 64 supplied from the hydrogen gas saturated extra pure water supplying device 61b to enhance the cleaning effect. Subsequently, hydrogen gas saturated extra pure water 64 is replenished by the hydrogen gas saturated extra pure water supplying device 61c since part of hydrogen gas saturated extra pure water 64 is dropped from the substrate 43 while being transported to be subjected to the third step, where ultrasonic cleaning is performed.

The ultrasonic cleaning unit 60 includes the hydrogen gas saturated water supplying device 61b which is included in the second step and the ultrasonic exciting device 66 for performing the third step.

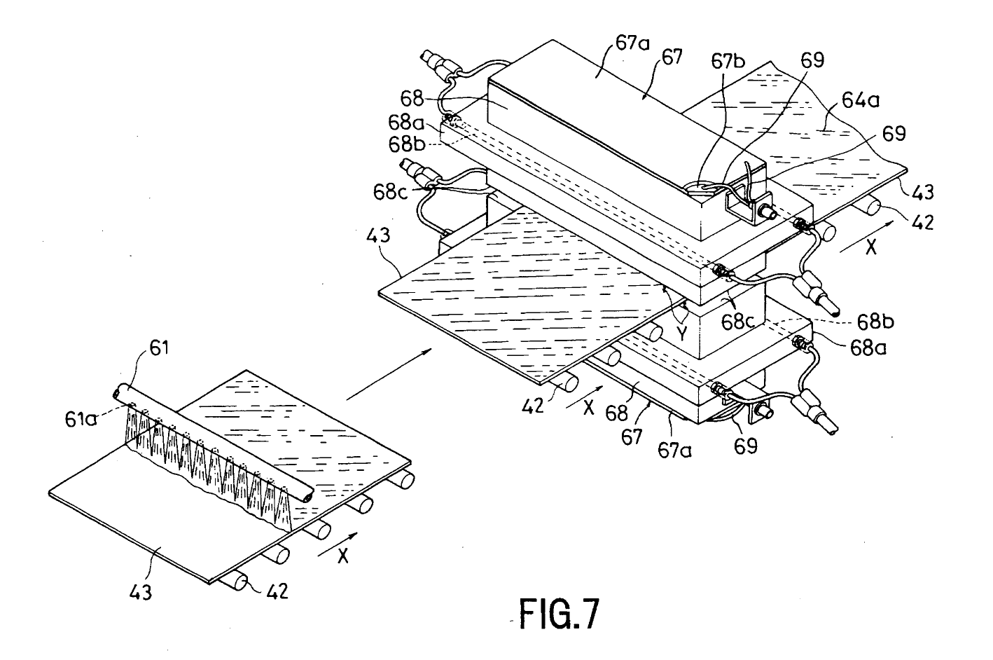

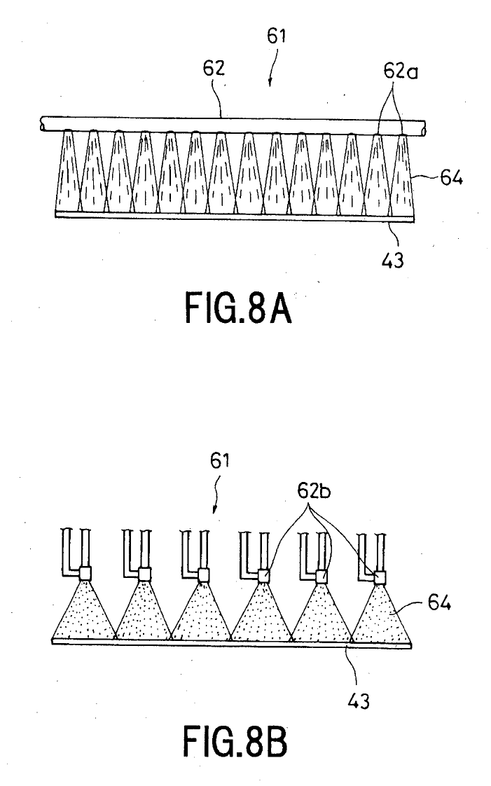

As shown in FIG. 4, FIG. 7 and FIG. 8, the hydrogen gas saturated extra pure water supplying device 61b is disposed on an upstream side of the ultrasonic exciting device 66 in order to enhance the cleaning effect of ultrasonic waves in the third step and prevent shortage of the liquid measure of the liquid film 64a formed on the substrate 43 in the previous step. It contributes to prevent such phenomenon that the liquid film 64a does not come into contact with the oscillating surface 68c of the ultrasonic exciting device 66 and thus ultrasonic waves are not propagated to the substrate 43 due to the shortage of the liquid measure.

A first example of the method of supplying hydrogen gas saturated extra pure water is shown in FIG. 7 and FIG. 8A. Hydrogen gas saturated extra pure water 64, which is manufactured (not shown) in advance, is injected toward the substrate 43 from a nozzle pipe 62 formed with a plurality of apertures 62a facing the substrate 43, so that both of the front and back surfaces of the substrate 43 are supplied with the hydrogen gas saturated extra pure water 64. As shown in FIG. 7, hydrogen gas saturated extra pure water 64 is supplied from the nozzle pipe 62 so that the entire surface of the substrate becomes wet. Since hydrophilic preparation has already made on the substrate in the first step, hydrogen gas saturated extra pure water 64 can easily be adapted itself to the substrate 43, and thus the liquid film 64a can easily be formed only with a small quantity of hydrogen gas saturated extra pure water 64.

FIG. 8B is a drawing showing a second example of the method of supplying hydrogen gas saturated extra pure water. As shown in FIG. 8, a plurality of dual-fluid nozzle 62b for mixing air and water pulverizing them are disposed so as to face the substrate 43, and fine mist is injected toward the substrate 43 instead of the nozzle pipe. When the dual-fluid nozzles 62b are used, the air is also injected as well as hydrogen gas saturated extra pure water, and hydrogen gas saturated extra pure water 64 can easily be adapted itself to the substrate 43 because hydrophiling preparation has made on the substrate 43 in the first step and thus the liquid film 64a can easily be formed with a small quantity of hydrogen gas saturated extra pure water 64. Therefore, the flow rate can be limited to 5 L/min. at maximum for the substrate (550 mm×650 mm×t0.7 mm), whereby the quantity of usage of hydrogen gas saturated extra pure water can be reduced significantly. In addition, the cleaning effect of the fact itself that cleaning solvent is injected from the dual-fluid nozzle 62b is also achieved.

Cleaning solvent 64 to be supplied to the substrate 43 may be, in addition to hydrogen gas saturated extra pure water, which is highly evaluated for its effect on removal of particles attached on the substrate 43 when combined with irradiation of ultrasonic waves, pure water, hydrochloric acid, ammonia, hydrofluoric acid, hydrogen peroxide solution, ozone water, alkali solution, oxidative or reducible drug solution, or anionic solution, as a matter of course. In particular, solutions which can enhance cleaning effect of ultrasonic waves are preferable.

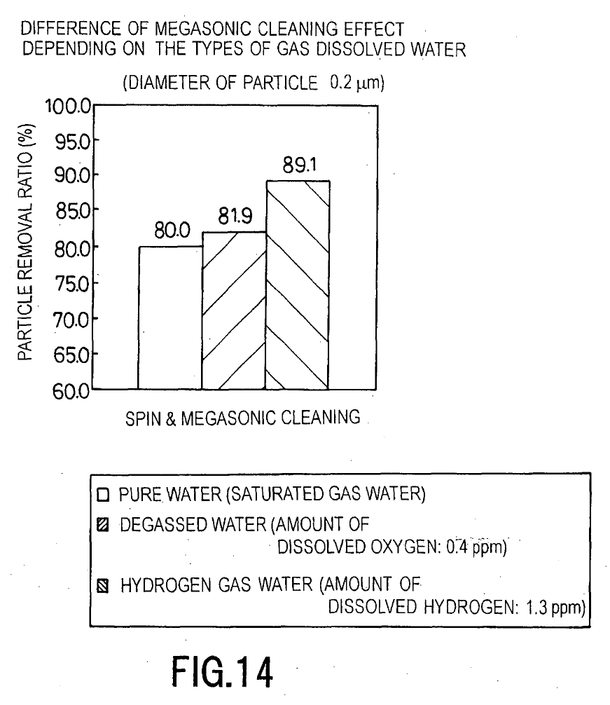

As an example of evaluation of cleaning performance of hydrogen gas saturated extra pure water, substrates used were 8-inch silicon substrates (bear silicon), which were contaminated in advance by particles of abrasive material such as slurry. The contaminated substrates were cleaned with pure water, degassed water, hydrogen gas saturated extra pure water, respectively, combined with ultrasonic waves of 1 MHZ. As a result, as shown in FIG. 14, the most effective cleaning solvent was hydro gas saturated extra pure water, followed by degassed water and pure water in the descending order. It is apparent from this result that the cleaning effect of hydrogen gas saturated extra pure water is high.

Although the flow rate of supplied hydrogen gas saturated extra pure water 64 depends on the transporting speed or the size of the substrate 43, flow rates in the range from 5 L/min to 50 L/min are preferable. The saturated concentration of hydrogen gas in the hydrogen gas saturated extra pure water is preferably 0.8 ppm or higher considering the effect of removal of particles.

As is clear from FIG. 4 and FIG. 7, when hydrogen gas saturated extra pure water 64 is supplied to the substrate 43 and the liquid film 64a is formed in the second step, ultrasonic waves are transmitted from the ultrasonic exciting device 66 through the liquid film 64a to the substrate 43 in the third step.

The ultrasonic exciting device 66 shown in FIG. 7 will be described.

The ultrasonic exciting device 66 includes a substantially cuboid waveguide body 68, a transducer 67 formed in the shape of a rectangular plate and bonded to the waveguide body 68 on one side with an adhesive agent or the like, and an oscillator (not shown) for applying a voltage of a predetermined driving frequency to the transducer 67, and is constructed to be used with the surface facing the upper surface of the waveguide body 68 including the transducer 67, that is, the oscillating surface 68c that emits ultrasonic waves, faced downward.

The oscillating surface 68c is provided in the vicinity of the liquid film 64a formed on the substrate 43 so as to be capable of coming into contact therewith. According to the embodiment of the invention, the distance between them is set to 2 mm or below, so as to extend in parallel with the surface of the plate-shaped substrate 43.

The transducer 67 includes a PZT (piezoelectric) element having an electrode plate 67a and an electrode plate 67b adhered on both sides thereof. Part of the lower electrode plate 67b is folded upward so as to be out of contact with the electrode plate 67a, and constitutes an electrode unit 67c. The length and the width of the transducer 67 are set to the values which are almost the same as the length L and the width W of the waveguide body 68, and a pair of power lines 69 for applying voltage of a predetermined driving frequency from the oscillator (not shown) is connected to predetermined positions on the electrode unit 67c and the electrode plate 67a, respectively.

When a voltage of a predetermined driving frequency is applied from the oscillator (not shown) to the transducer 67, the transducer 67 generates ultrasonic vibrations of this frequency.

The waveguide body 68 vibrates sympathetically with ultrasonic vibrations generated by the transducer 67, and serves as a member for transmitting the ultrasonic vibrations to the liquid film 64a of the hydrogen gas saturated extra pure water 64 formed in advance.

Subsequently, the operation of the ultrasonic exciting device 66 will be described.

When a voltage of a predetermined driving frequency is applied from the oscillator (not shown) to the transducer 67, the transducer 67 is excited, and generates ultrasonic vibrations of this frequency. The generated ultrasonic vibrations are transmitted through the waveguide body 68 to the liquid film 64a of hydrogen gas saturated extra pure water 64 supplied under the waveguide body 68 as an external load.

The oscillating surface 68c of the waveguide body 68 for supplying ultrasonic waves is provided in the vicinity of the liquid film 64a formed on the substrate 43 so as to be capable of coming into contact therewith, that is, at a distance of 2 mm or below in the embodiment of the invention. Since the distance between the ultrasonic transducer 67 and the substrate 43 is small, ultrasonic power is attenuated only by a small extent, and resonance frequencies of the ultrasonic element are included within the range from 15 kHz to 3 MHz.

The ultrasonic exciting device 66 does not transmit ultrasonic vibrations to the substrate 43, which corresponds to the object to be processed 43, such as a glass substrate, if hydrogen gas saturated extra pure water 64 is not supplied under the oscillating surface 68c as an external load.

A gap formed between the surface of the substrate 43 and the oscillating surface 68c, that is, the distance therebetween is set to the value below about 2 mm, and the substrate 43 is transported by the drive rollers 42, which correspond to transmitting means, in the direction of travel indicated by an arrow X (shown in FIG. 7).

Since the hydrophilic preparation is made in the first step in advance, and hydrogen gas saturated extra pure water 64 is supplied onto the substrate 43 and thus the liquid film 64a is formed by the action of surface tension in the second step, the gap between the surface of the substrate 43 and the oscillating surface 68c come into contact with each other via the liquid film 64a and thus oscillating vibrations from the transducer 67 are transmitted to the substrate 43. Therefore, the ultrasonic exciting device 66 can perform cleaning of the substrate 43 by the action of the liquid film 64a of the hydrogen gas saturated extra pure water 64.

In the embodiment described above, the pair of ultrasonic cleaning units 60 is disposed above and below the substrate 43 corresponding to the front and back surfaces of the substrate. However, when cleaning in the third step is to be performed only on one side of the substrate 43, but not on both sides, formation of the liquid film 64a must simply be done on the cleaning surface, and it is also possible to provide the ultrasonic cleaning unit 60 only on one side. Correspondingly, irradiation of ultraviolet light in the first step may be performed only on one side, or may be performed by disposing the ultraviolet light irradiating device 51 only on one side.

As shown in FIG. 4, a plurality of ultrasonic cleaning units 60 are disposed for cleaning depending on the dimensions of the substrate 43, the deposit efficiency of particles thereon, or the required cleanliness. However, it is not necessary to provide the same number of hydrogen gas saturated extra pure water supplying devices 61 as the number of ultrasonic exciting device 66 on the upstream sides of the respective ultrasonic exciting devices 66 for supplying hydrogen gas saturated extra pure water 64 to the substrate 43 and forming the liquid film. As long as the liquid film has formed in the previous step, a construction having no hydrogen gas saturated extra pure water supplying deice 61 on the upstream sides from the second ultrasonic exciting devices 66 on may also be employed. In addition, in the case in which the same number of hydrogen gas saturated extra pure water supplying devices 61 as the number of the ultrasonic exciting devices 66 are provided on the upstream sides of the respective ultrasonic exciting devices 66 or in the case in which the plurality of hydrogen gas saturated extra pure water supplying devices 61 are provided, but some of the hydrogen gas saturated extra pure water supplying devices 61 are omitted, the second and the subsequent hydrogen gas saturated extra pure water supplying devices 61 do not have to supply the same quantity of hydrogen gas saturated extra pure water as the hydrogen gas saturated extra pure water supplying device 61 provided on the upstream of the first ultrasonic exciting device 66. It is also possible to reduce the quantity of hydrogen gas saturated extra pure water supplied from the second and the subsequent hydrogen gas saturated extra pure water supplying devices 61 disposed between the ultrasonic exciting devices 66, and to supply only for the purpose of replenishment.

The results of cleaning operations conducted with three ultrasonic exciting devices 66 each associated with the hydrogen gas saturated extra pure water supplying devices 61 on the upstream side thereof (condition 1), and with three ultrasonic exciting devices 66 but the hydrogen gas saturated extra pure water supplying device 61 on the upstream side of the second ultrasonic exciting device 66b being omitted (condition 2) will be shown.

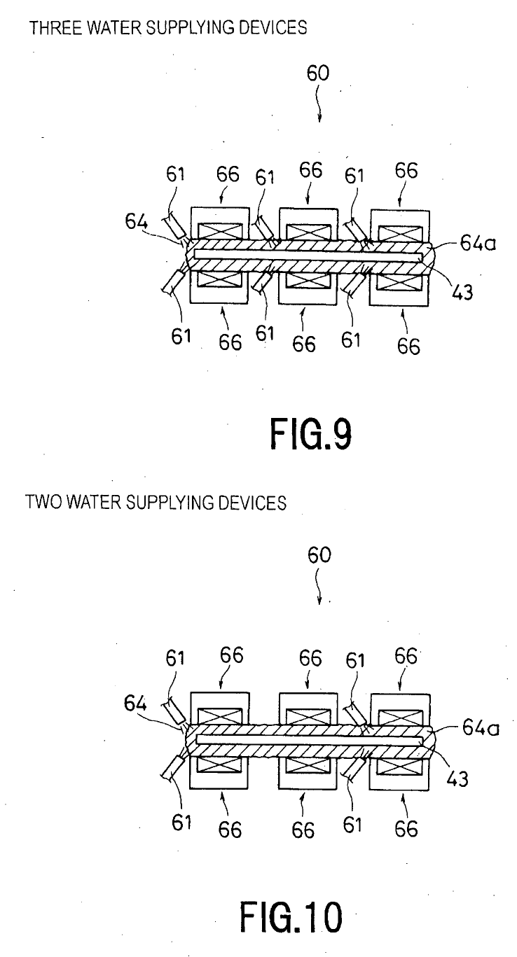

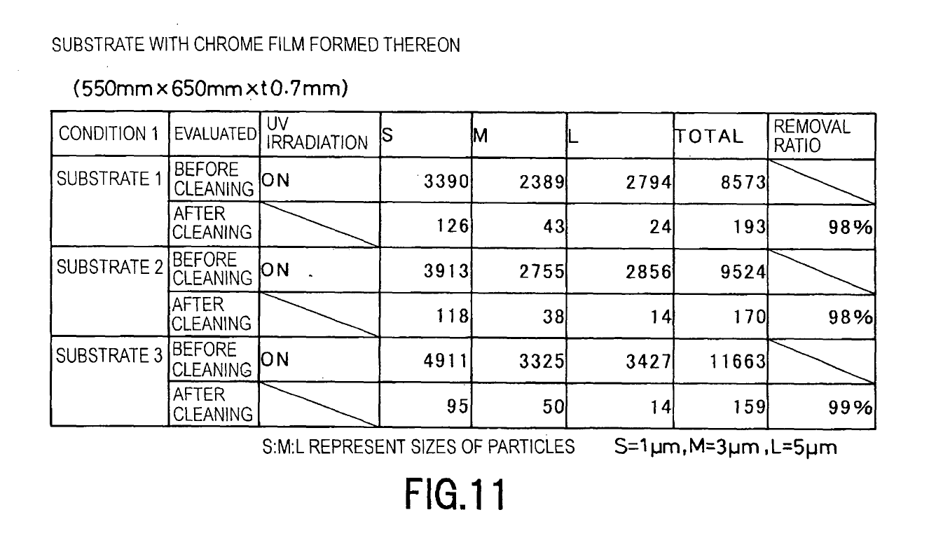

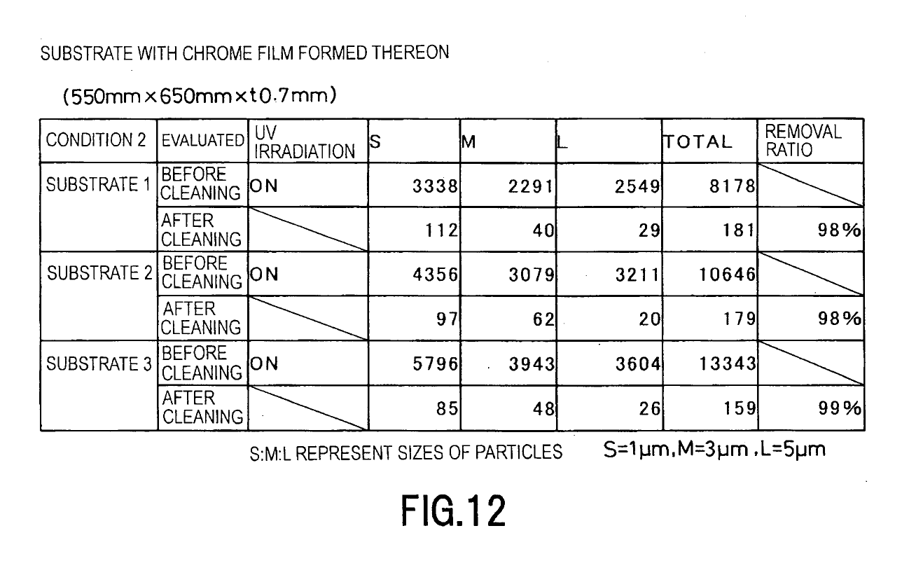

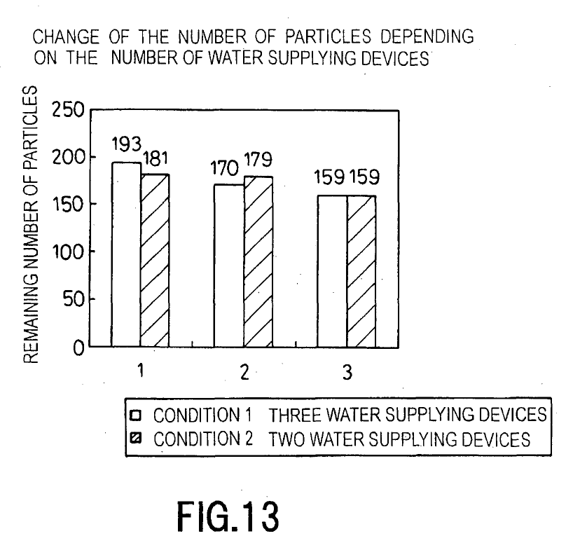

FIG. 9 shows the case in which three ultrasonic exciting devices 66 are provided, and the hydrogen gas saturated extra pure water supplying devices 61 are provided on the upstream side of the respective ultrasonic exciting devices 66. FIG. 10 shows the case in which three ultrasonic exciting devices 66 are provided, but the hydrogen gas saturated extra pure water supplying device 61 on the upstream side of the second ultrasonic exciting device 66 is omitted. FIG. 11 is a table showing the result of cleaning in the case shown in FIG. 9, and FIG. 12 is a table showing the result of cleaning in the case shown in FIG. 10. FIG. 13 is a graph showing comparison between the cases shown in FIG. 11 and FIG. 12.

As is clear from FIG. 11 to FIG. 13, when three such ultrasonic exciting devices 66 are provided, there was no difference in the cleaning results between the case where the hydrogen gas saturated extra pure water supplying devices 61 are provided on the upstream side of every three ultrasonic exciting devices 66 (condition 1) and the case where the hydrogen gas saturated extra pure water supplying device 61 on the upstream side of the second ultrasonic exciting device 66 is omitted (condition 2). Therefore, it is not necessary to provide the same number of hydrogen gas saturated extra pure water supplying devices 61 on the upstream sides of the respective ultrasound exciting devices 66 for supplying hydrogen gas saturated extra pure water 64 to the substrate 43 to form the liquid film thereon. The construction having no hydrogen gas saturated extra pure water supplying device 61 for the second and the subsequent ultrasonic exciting devices 66 may also be employed as long as the liquid film is formed on the substrate.

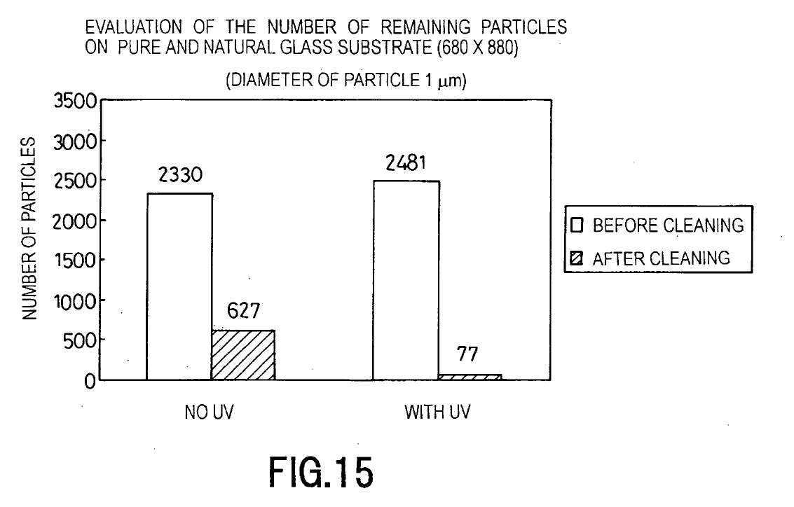

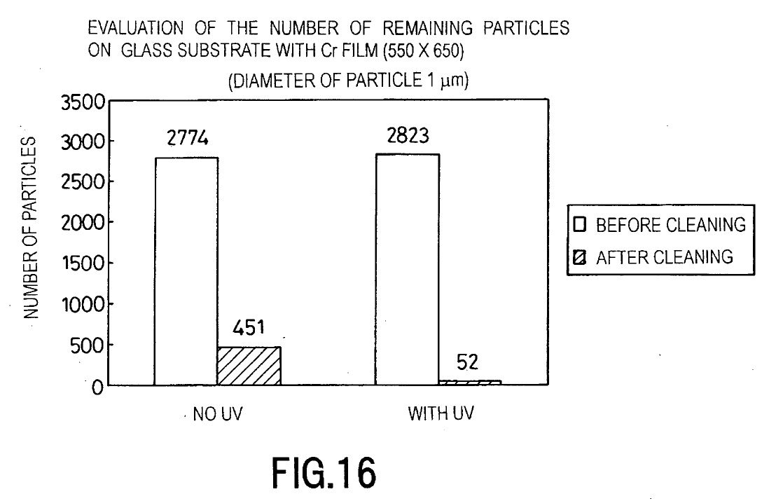

FIG. 15 to FIG. 17 show examples of evaluation of cleaning performance of the cleaning method and the cleaning apparatus according to the present invention. FIG. 15 shows a result of cleaning of particles on the pure and natural glass substrate with and without ultraviolet treatment, and FIG. 16 shows a result of cleaning of particles on the substrate having a Cr film formed thereon with and without ultraviolet treatment.

The substrates used here were a pure and natural glass substrate (680×880 mm×t0.7 mm) and a substrate having chrome developed thereon (hereinafter referred to as Cr substrate: 550×650 mm×t0.7 mm). When the pure and natural glass substrate and the substrate 43 with Cr film formed thereon were measured, the number of particles on the surface of the pure and natural glass substrate were 2330, or 2481 (those having 1.0 μm or larger in diameter) (FIG. 15), and the number of particles on the Cr substrate was 2774, or 2823 (FIG. 16). The substrate 43 having subjected to ultraviolet treatment (ultraviolet light of 70 mJ/cm² was irradiated onto the substrate for 12 seconds) and the substrate 43 without having subjected to ultraviolet treatment were cleaned with hydrogen water and ultrasonic waves, and the numbers of particles remained on the substrates 43 after cleaning were measured. Measurement was made by GI4920 from Hitachi Electronics Engineering Co.,Ltd. Consequently, as shown in FIG. 15 and FIG. 16, it was proved that the number of remaining particles was smaller and hence the cleaning effect was higher on the substrate having subjected to ultraviolet treatment for both of the pure and natural glass substrate and the Cr substrate. In the evaluation of the contact angle of the pure glass substrate with and without ultraviolet treatment shown in FIG. 17, it was proved that the contact angle was smaller (the remaining number of particles was smaller) and hence the cleaning effect was higher in the case of having subjected to the ultraviolet treatment.

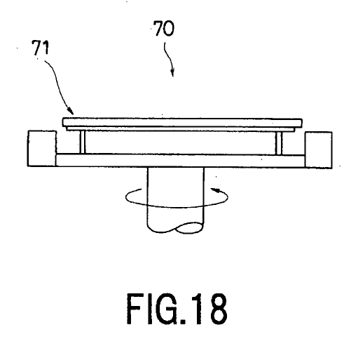

After having subjected ultrasonic cleaning in the second step, the substrate 43 proceeds to the substrate drying step, which corresponds to the third step, via transportation by the drive rotors 42, in which the substrate 43, which is wet with hydrogen gas saturated extra pure water 64, is dried. Generally known drying methods using the dryer unit 70 are spin drying, IPA steam drying, Marangoni drying, and air knife drying. The object to be processed is dried by one or combination of these methods. For example, in the spin drying, as shown in FIG. 3A and FIG. 18, the substrate 43 is dried by being rotated by a spin dryer 71. In the air knife dying, as shown in FIG. 3B and FIG. 4, the substrate 43 or the wafer is dried by blowing a large quantity of air. In the IPA steam drying, the substrate 43, which is wet with water, is raised and dried while being displaced by steam of IPA (Isopropyl alcohol). In Marangoni drying, the substrate 43 is dried using Marangoni effect.

Therefore, according to the invention, in the first step, the organic substances are decomposed and peeled from the surface of the substrate 43 by irradiating ultraviolet light 54 on the substrate 43, or by cleaning with ozone water, then hydrophiling preparations are made utilizing the fact that the substrate 43 is provided with hydrophilic nature (becomes wettable) in accordance with reduction of the organic substances attached on the surface of the substrate 43. In the second step, when supplying hydrogen gas saturated extra pure water to the substrate 43, since the hydrophiling preparation (provision of wettability) has made in the first step, the liquid film 64a of hydrogen gas saturated extra pure water 64 can easily be formed on the substrate 43 with a small quantity of liquid. In addition, since the ultrasonic oscillating surface 68c is disposed in the vicinity of the liquid film of hydrogen gas saturated extra pure water 64 formed on the substrate 43 so as to be capable of coming into contact therewith in the third step, attenuation of ultrasonic power is reduced. Therefore, in cooperation with an effect of using the hydrogen gas saturated extra pure water used as cleaning solvent, a high cleaning effect is achieved, while enabling propagation of ultrasonic power to the substrate 43 with a small quantity of cleaning solvent.

As described thus far, according to the invention, making hydrophiling preparation on the surface of the substrate (surface to be cleaned) increases wettability of the substrate, thereby achieving high cleaning effect. Using hydrogen gas saturated extra pure water for cleaning achieves higher cleaning effect than the case where extra pure water is used. In addition, irradiation of ultrasonic waves in the vicinity of the liquid film formed on the substrate significantly reduces the quantity of cleaning solvent required, and reduces attenuation of ultrasonic power. Furthermore, since hydrophiling preparation is made on the substrate, the liquid film can easily be formed, and thus the quantity of cleaning solvent required can be reduced significantly.

1. A cleaning method comprising:
a first step of transporting a plate-shaped object to be processed by a transporting device on a support stand and making hydrophiling preparation on at least one of the surfaces of the object to be processed;
a second step of forming a liquid film on the surface of the object to be processed, on which hydrophiling preparation has made; and
a third step of irradiating ultrasonic energy from an ultrasonically oscillating surface provided in the proximity of the liquid film formed on the surface of the object to be processed so as to be capable of coming into contact therewith onto the object to be processed for cleaning.

2. A cleaning method according to claim 1, wherein the hydrophiling preparation is made by optical cleaning or ozone cleaning.

3. A cleaning method according to claim 2, wherein the optical cleaning is performed by irradiating ultraviolet light onto the object to be processed by an excimer lamp or a low-pressure mercury lamp.

4. A cleaning method according to claim 1, wherein the liquid film is formed by hydrogen gas saturated extra pure water.

5. A cleaning method according to claim 4, wherein the saturated concentration of the hydrogen gas saturated extra pure water is 0.8 ppm or higher.

6. A cleaning method according to claim 1, wherein the liquid film is formed by being mixed with air and applied on the hydrophilic surface of the object to be processed from a two-fluid nozzle.

7. A cleaning method according to claim 1, wherein the object to be processed is cleaned by being transported horizontally or vertically by the transporting device.

8. A cleaning method according to claim 1, wherein the cleaning method further comprises a fourth step of drying the object to be processed by one or combination of IPA steam drying, spin drying, Marangoni drying, and air knife drying.

9. A cleaning apparatus for irradiating ultrasonic energy onto the object to be processed and cleaning the same, comprising:
a transporting unit for transporting the plate-shaped object to be processed on a support stand by transporting means;
a hydrophiling unit for making hydrophiling preparation on at least one of the surfaces of the object to be processed;
an ultrasonic cleaning unit including a cleaning solvent supplying device for forming a liquid film on the surface of the object to be processed, on which hydrophiling preparation has made; and
an ultrasonic exciting device provided in the vicinity of the liquid film formed on the surface of the object to be processed so as to be capable of coming into contact therewith.

10. A cleaning apparatus according to claim 9, wherein the hydrophiling unit includes au ultraviolet light irradiating device or an ozone water cleaning unit.

11. A cleaning apparatus according to claim 9, wherein the ultraviolet light irradiating device irradiates ultraviolet light onto the object to be processed by an excimer lamp or a low pressure mercury lamp.

12. A cleaning apparatus according to claim 9, wherein the liquid film is formed by a hydrogen gas saturated extra pure water supplying device.
